(19) United States
(12) Patent Application Publication
(10) Pub. No.: US 2005/0217413 A1
(43) Pub. Date: Oct. 6, 2005

(54) Steering wheel skeleton

(76) Inventors: Martin Specht, Feldafing (DE); Thomas Heckmayr, Rammingen (DE)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/926,663

(22) Filed: Aug. 27, 2004

(30) Foreign Application Priority Data
Mar. 30, 2004 (DE) 10 2004 015 529.1

(51) Int. Cl. G05G 1/10

(52) U.S. Cl. 74/552; 280/731

(57) ABSTRACT

A steering wheel skeleton is made of a high-strength polyphase fine sheet steel and has a rim, spokes and a plane support plate that extends perpendicular to the axis of rotation of the steering wheel and onto which the hub is secured.

### FIELD OF THE INVENTION

The present invention relates to a steering wheel for a vehicle.

### BACKGROUND OF THE INVENTION

U.S. Pat. No. 3,714,844 discloses a steering wheel with a steering wheel skeleton comprising a flat metallic base material. The steering wheel skeleton comprises a steering wheel rim, spokes and a hub region that is connected to the radially inner ends of the spokes and on which a hub comprising a hub body is secured. The flat metal base material is formed as a casting. The hub is connected to the steering wheel skeleton on both its bottom side and its top side, whereby relatively narrow support surfaces are formed on shoulders on the hub.

EP 0 814 010 B1 discloses a steering wheel skeleton comprising a hub, spokes and rim in one piece and formed into its final shape by a process of reshaping of a sheet steel sheet section without cutting. For the formation of the hub, the steel sheet section comprises in the hub region a material doubling to provide the required stiffness and sufficient material for a serration.

### SUMMARY OF THE INVENTION

There is provided in accordance with the present invention a steering wheel skeleton comprising a rim, spokes and a hub region that is connected to the radially inner ends of the spokes and on which a hub comprising a hub body is to be secured, wherein the steering wheel skeleton comprises a high-strength polyphase fine sheet steel.

### BRIEF DESCRIPTION OF THE DRAWINGS

FIG. 1 is a perspective view of a steering wheel skeleton and a hub that is to be connected thereto for an embodiment of the invention.

FIG. 2 shows the embodiment represented in FIG. 1 in an assembled state.

FIG. 3 is an exploded view of an airbag module and a steering wheel of FIGS. 1 and 2.

FIG. 4 is a top view of a spring-loaded latch used in the embodiment of FIGS. 1 to 3.

FIG. 5 shows the airbag module assembled with the steering wheel skeleton of FIGS. 1 to 3.

FIG. 6 is an exploded view of a further embodiment of a steering wheel skeleton, steering wheel cover and airbag module.

FIG. 7 shows a further embodiment of a spring-loaded latch that can for instance be used in the embodiment of FIG. 6.

FIG. 8 is a cross section of the rim of the steering wheel skeleton that can be used in the steering wheel of the present invention.

FIG. 9 is a perspective view of an assembled steering wheel skeleton according to a further embodiment.

FIG. 10 is a top view of the steering wheel skeleton of the embodiment shown in FIG. 9.

FIG. 11 is a perspective view of a hub for the embodiment of FIG. 9.

### DETAILED DESCRIPTION OF THE INVENTION

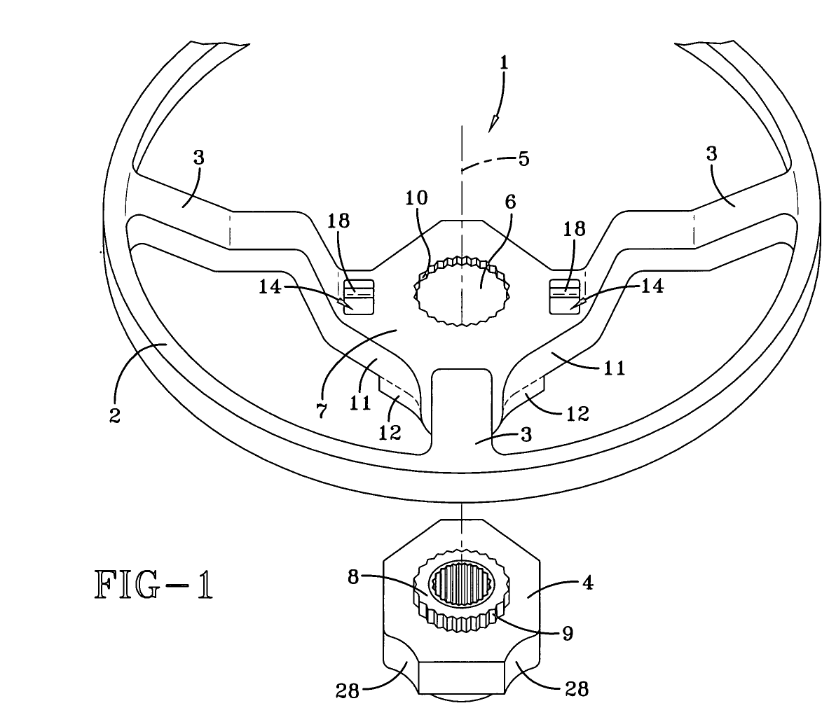

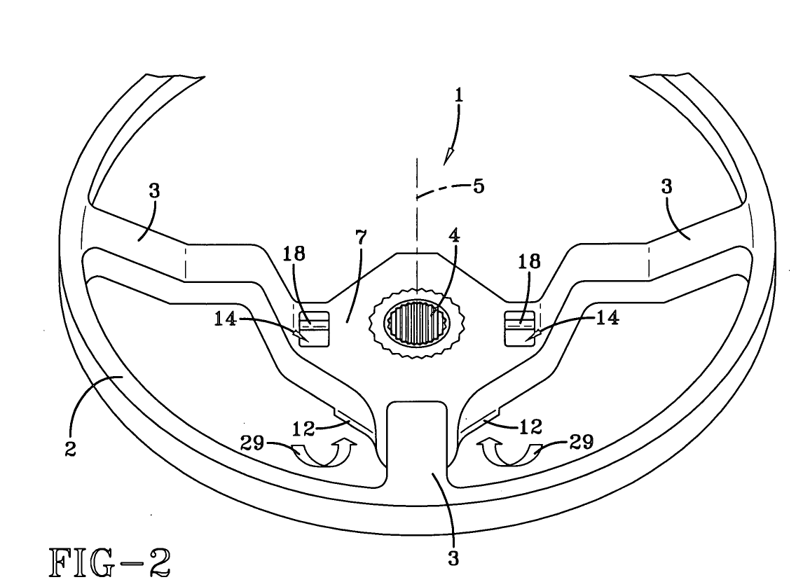

A steering wheel according to the present invention has utility with a motor vehicle, but may also be employed with other vehicles such as watercraft or any other machine requiring a steering wheel. The represented embodiments have a steering wheel skeleton 1. The steering wheel skeleton comprises a rim 2, spokes 3 and a hub region in the form of a support plate 7 connected to the radially inner ends of the spokes. A hub 4 comprising a hub body is to be secured to the support plate 7. For the purpose of securing the hub 4 to the steering wheel skeleton 1, the hub 4 has a hub projection 8 projecting from its top side. The hub projection 8 is inserted through an opening 6 in the support plate 7. This ensures that the hub 4 can be arranged so that the axis of rotation 5 of the steering wheel is coaxial with a steering wheel shaft on which the steering wheel is mounted. A non-rotatable connection is created between the opening 6 and the hub 4 using the hub projection 8 and the inner circumference of the opening 6. The non-rotatable connection can be created by a serration or, preferably, as is shown in FIGS. 1 and 2, by circumferentially arranged teeth or serrations that are complementary to the exterior profile of the steering shaft. The hub projection 8 has teeth 9 on its circumference and the opening 6 has complementary teeth 10 on its inner circumference (FIG. 1). In the assembled state the entire surface of the top side of the hub 4 is attached to the bottom side of the support plate 7. For additional securing of the hub 4 to the steering wheel skeleton 1, downward projecting sheet parts 11 are provided on the support plate 7, which in an assembled state are attached in a positive locking manner to the side surfaces 28 of the hub body. The side surfaces 28 of the hub body can be bent inwards, whereby the sheet parts 11 attached to the side surfaces 28 have a corresponding bend. In this manner an additional non-rotatable connection is created between the hub 4 and the steering wheel skeleton 1. The downward projecting sheet parts, which can extend parallel to the steering wheel's axis of rotation 5, comprise lower ends 12, which can be bent towards the steering wheel's axis of rotation 5, as indicated in FIG. 2 by arrows 29. In this manner attachment of the hub 4 to the steering wheel skeleton 1 is also ensured from the bottom in an axial direction. On the top side of the hub 4 the axial securing is ensured by the bottom side of the sheet 7. The downward projecting sheet parts are positioned between the spokes 3 of the steering wheel skeleton 1.

The hub region for securing the hub is preferably formed by a plane support plate extending essentially perpendicular to the steering wheel shaft and comprising an opening around the steering wheel shaft. The hub is formed by a solid hub body with a through bore which on its top side comprises a medium-sized hub projection. The hub projection is inserted through the opening of the support plate and comprises on its circumference a shaping which with the inner circumference of the opening forms a non-rotatable connection. A serration created by one or several teeth and corresponding recesses can be provided between the circumference of the hub projection and the inner circumference of the opening. Circumferentially extending teeth engaging one another are preferably created on the inner circumference of the opening and on the outer circumference of the hub projection.

The skeleton base body for the steering wheel skeleton 1 is a steel sheet section made from a high-strength polyphase fine sheet steel. The steel sheet section can for instance be fabricated by stamping out of fine sheet steel. The final shape of the steering wheel skeleton 1 is achieved by a process of sheet reshaping without cutting, in particular by deep-drawing. In this manner the support plate 7 is given its shape which is sloped relative to the rim 2, whereby the spokes 3 can display a slanted or graduated shape, as can shown in the figures. The spokes 3 and the rim 2 can have an open cross-section form, for instance an essentially U-shaped or V-shaped or similar form. The rim 2 preferably has a closed form, whereby the closed form, as shown in FIG. 8, can comprise one or two facing indentations 13.

As already described above, during the deep-drawing or during the final shaping of the steering wheel skeleton, in particular in the hub region, the hub 4 can be secured to the support plate 7.

The high-strength polyphase fine sheet steel, out of which the steering wheel skeleton 1 is made, can for instance comprise a dual phase steel (cold rolled or hot rolled), the structure of which consists essentially of ferrite with a martensite content of up to approximately 20%. A dual phase steel (TRIP steel) with a ferrite/bainite matrix base and retained austenite elements, which during the reshaping process convert to hard martensite, is also suitable. This type of fine sheet steel is used during the bodywork manufacturing of motor vehicles. The base body of the steering wheel skeleton comprises a steel sheet section that is preferably formed by stamping from the polyphase fine sheet steel. The polyphase fine sheet steel is preferably a dual phase fine sheet steel. This sheet can display a thickness of 0.70 mm to 1.50 mm, for example 1.25 mm. The yielding point of the fine sheet steel lies between 320 N/mm² and 400 N/mm², preferably 380 N/mm². The tensile strength of the fine sheet steel measures 570 N/mm² to 700 N/mm², preferably 600 N/mm².

The reshaping during the forming of the steering wheel skeleton is preferably carried out by deep drawing. The draw point ratio of the high-strength fine sheet steel for this purpose lies preferably between 1.75 and 2.00 with a sheet thickness of 1 mm and with deep-drawing using a hemispherical plunger, which displays a diameter of 160 mm. The sheet steel preferably has a draw point ratio of approximately 1.9.

The support surface is arranged in a depression on the steering wheel skeleton. This depression can be created by a slanted arrangement and/or a graduated shape of the spokes. In this manner an assembly space for an airbag module is created in the skeleton interior on the top side of the support surface. The airbag module can be securely connected to the steering wheel skeleton preferably by spring-loaded latches and/or plug-in connections in the region of the support plate or in the region of the spokes.

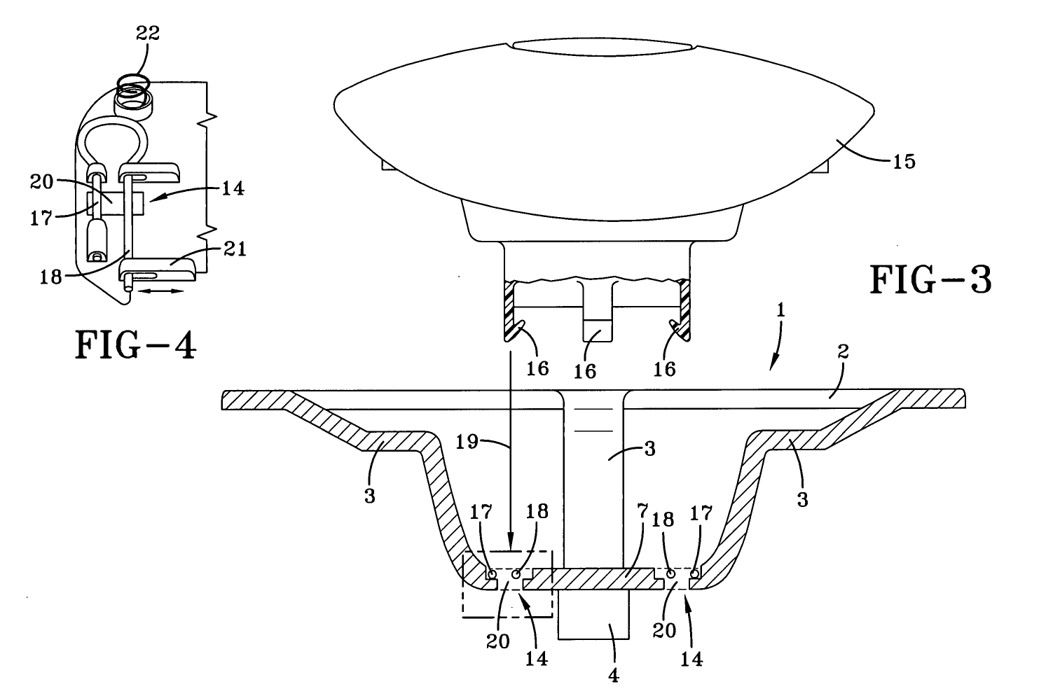

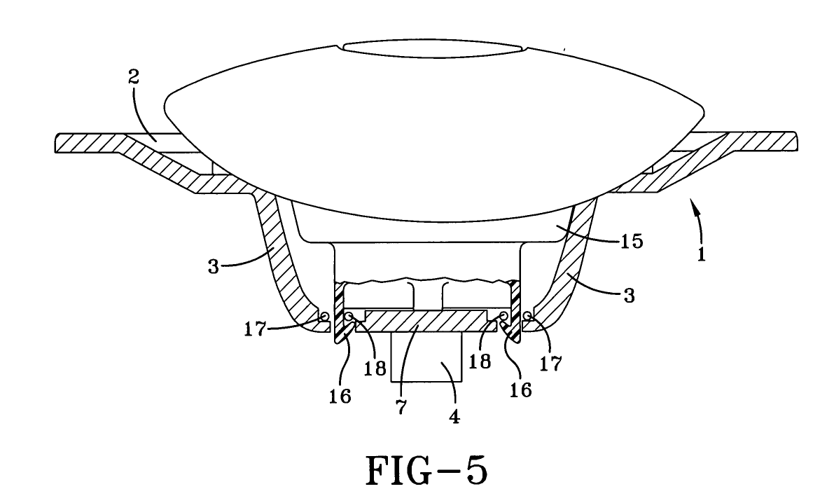

In the figures the support plate 7 is positioned in a depression in the hub region facing the rim 2. This facilitates the installation of an airbag module 15. The securing of the airbag module 15 is preferably carried out by spring-loaded latches 14 that can be provided on the spokes 3 or in the region of the support plate 7. In the embodiments of FIGS. 1 to 5, the spring-loaded latches 14 are provided in the region of the support plate 7. The spring-loaded latches are positioned outside the top side of the hub 4, which is pressed against the bottom side of the support plate 7. In the embodiments of FIGS. 1 to 5, the spring-loaded latches are positioned between the radially inner ends of the spokes and the hub body. In each case the spring-loaded latch 14 can comprise a leg spring 17, 18, whereby the leg spring is preferably designed to be hairpin-shaped or U-shaped with two spring legs 17, 18 (FIGS. 3 to 5). On the airbag module 15 an engagement part 16 is allocated to each spring-loaded latch 14. The engagement parts 16 are hook-shaped and in a plugged-in state they lock with one of the two spring legs of the corresponding spring-loaded latch 14. In the represented embodiment one spring leg 17 is immovably secured to the steering wheel skeleton 1. The other spring leg 18 is resiliently movable. The resiliently movable spring leg 18 extends across an opening 20, which is provided in the sheet material of the steering wheel skeleton in the outer region of the support plate 7 for each spring-loaded latch 14. In the represented embodiment, three spring-loaded latches 14 and three allocated engagement parts 16 are provided on the airbag module 15. The airbag module 15 is, as shown in FIG. 3, moved from above in the plug-in direction 19 towards the support plate 7, whereby the engagement part 16, in each case provided with a hook, is moved in between the two spring legs 17, 18. Due to its resilient mobility, the spring leg 18 is moved to one side during the insertion of the engagement part 16 into the opening 20. As soon as the hook of the engagement part 16 lies behind the movable spring leg 18, the movable spring leg moves back into its initial position, which is shown in FIG. 4. In FIG. 5 the engagement part 16 of the airbag module positioned between the two spring legs 17, 18, whereby the hook of the engagement part 16 lies underneath the resilient spring leg 18. In this manner a secure positioning of the airbag module 15 on the steering wheel is ensured. A defined guide of the movable spring leg 18 is ensured by the guide 21 in the steering wheel skeleton that is a slot or elongated hole as shown in FIG. 4.

A bias can be exerted on the airbag module 15 by a spring 22 opposing the plug-in direction 19, so that the angle of the hook is pressed against the spring leg 18, whereby additional securing is achieved. For this purpose, the spring 22 is positioned in the proximity of the spring-loaded latch 14 and supports its locking effect.

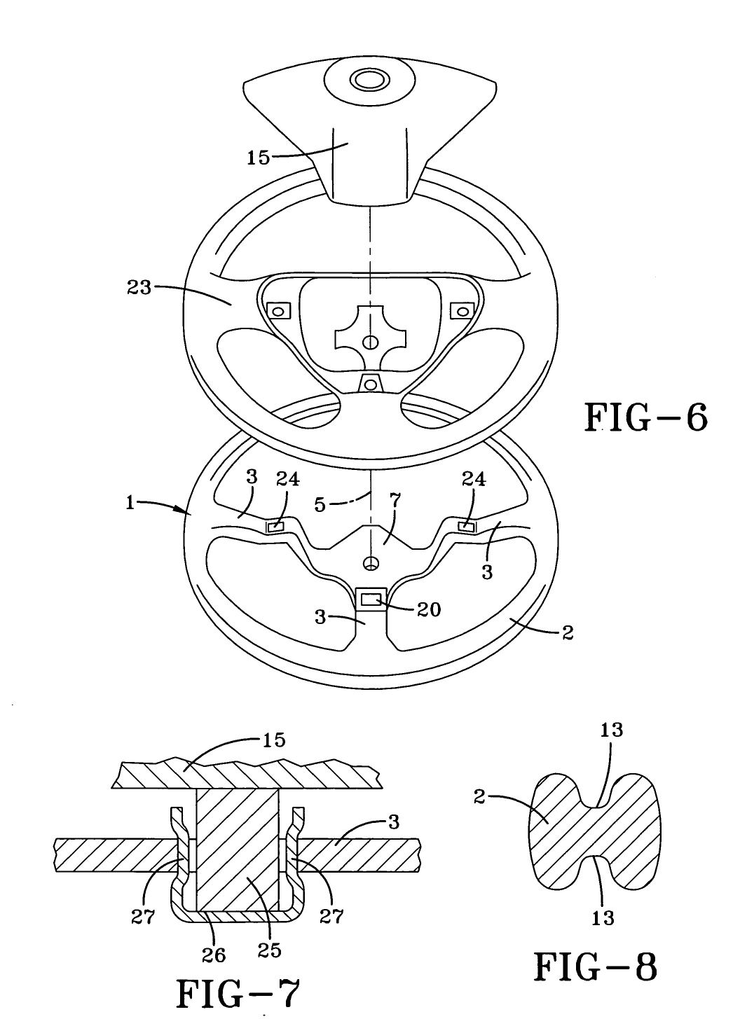

In the embodiment shown in FIG. 6, the openings 24 for receiving the spring-loaded latches are provided on the spokes 3. The openings 24 are positioned in spoke regions extending essentially perpendicular and radial to the steering wheel shaft 5. Allocated engagement parts are provided on the bottom side of the airbag module 15, a cross section of one of the engagement parts being shown in FIG. 7. The engagement part of FIG. 7 comprises a plunger 25, which is secured to the bottom side of the airbag module 15. An essentially U-shaped spring is secured to the plunger 25. The U-shaped spring has two spring legs 27 are biased to extend outwardly from the U. On the spring legs 27, bowed portions 13 can be provided, which are resiliently mated with the inner periphery of the opening 24 to secure the airbag module 15 to the steering wheel skeleton 1.

The two embodiments of the latches show that they can be released from their locking positions. Upon pressing the two spring legs 27 together, the lock shown in FIG. 7 can be released and the airbag module 15 can be removed upwards. In the spring-loaded latches 14 shown in FIGS. 3 to 5, the lock can be released by pushing the airbag module against the force of the spring 22 and by the movement of the spring leg 18 out of the engagement position with the hook of the engagement part 16 and the airbag module can be moved upwards.

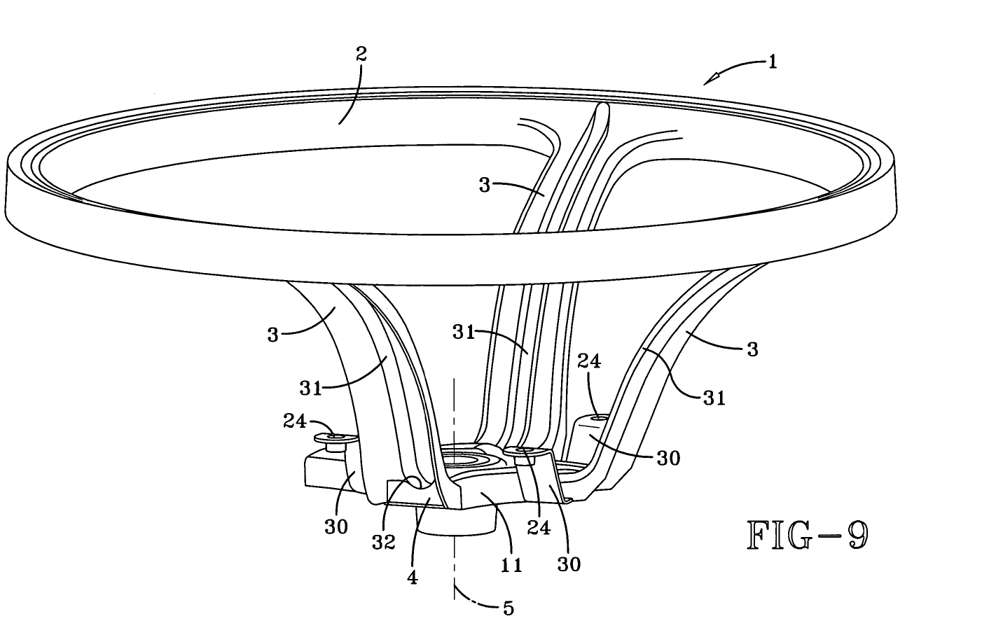

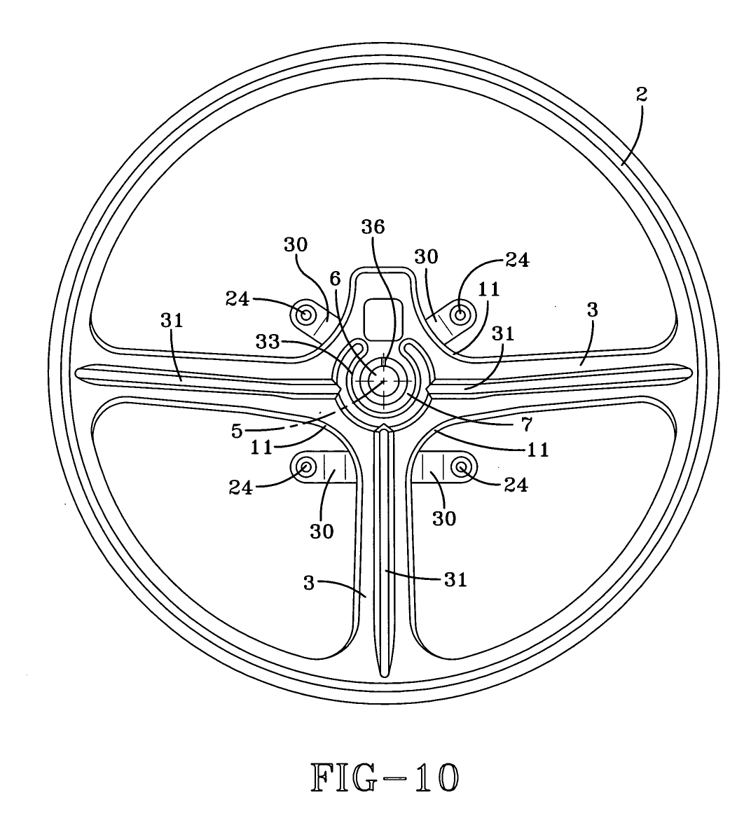

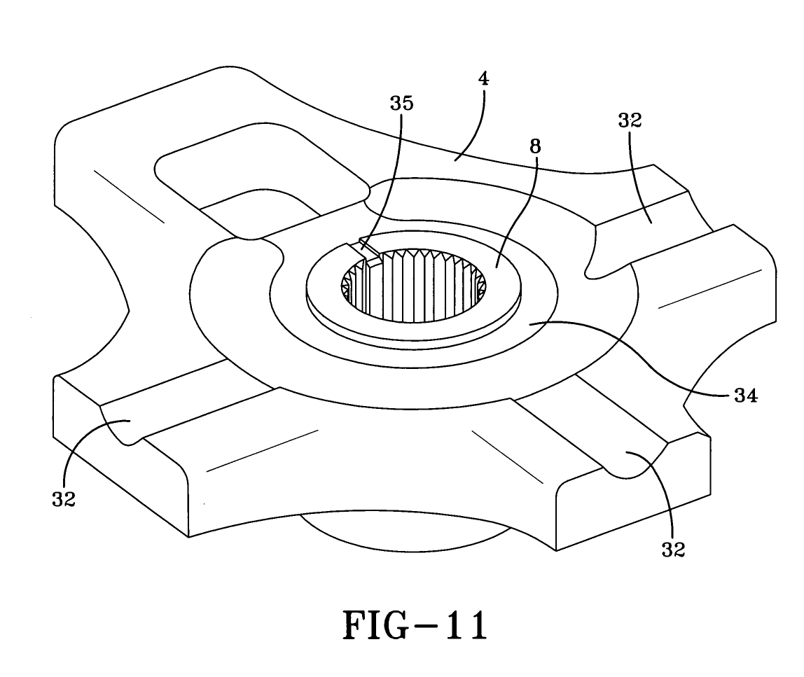

In FIGS. 9, 10 and 11, a further embodiment of a steering wheel according to the present invention is represented. The hub 4 shown in FIG. 11 has two grooves 32 therein extending approximately perpendicular to one another on the surface that will contact the bottom side of the support plate 7. In addition, an arcuate-shaped depression 34 is provided in the surface of the hub body. The hub projection 8 has a notch 35 therein. The mentioned formed shapes on the hub body enter into a positive locking engagement with complementary shapes on the bottom side of the support plate 7. The support plate and spokes have ribs 31, which in an assembled state are positioned in the grooves 32 of the hub 4. In addition a projection 36 is provided on the bottom side of the support plate 7 for engaging the notch 35 in the hub projection. In this manner a non-rotatable connection between the hub 4 and the steering wheel skeleton 1 is ensured. To align the axis of rotation 5 of the hub 4 with a steering shaft, on the bottom side of the support plate 7 an arcuate-shaped projection 33 is provided, which in an assembled state lies in the arcuate-shaped depression 34 of the hub 4.

The sheet parts 11 projecting downward between the spokes 3 are pushed to the side surfaces of the hub 4 by pressure, in particular high pressure to achieve a more or less cold-welded connection. This results in an anchoring of the hub 4 to the steering wheel skeleton 1 without bending the sheet parts 11 around the bottom side of the hub 4. Sheet parts 12, as shown in the embodiment of FIG. 1, are not required in this configuration.

To secure the airbag module 15 (not represented in detail) to the steering wheel openings 24 for spring-loaded latches or retention devices for securing the airbag module as described above are provided on upwardly bent straps 30, which are made in one piece with the steering wheel skeleton. The straps 30, together with the surfaces in which the openings 24 are arranged for the spring-loaded latches, extend beyond the top side of the support plate 7 as shown in FIG. 9.

Many changes and modifications in the above described embodiments of the invention can, of course, be carried out without departing from the scope thereof. Accordingly, that scope is intended to be limited only by the appended claims.

1. A steering wheel skeleton comprising a rim, spokes and a hub region that is connected to the radially inner ends of the spokes and on which a hub comprising a hub body is to be secured, wherein the steering wheel skeleton comprises a high-strength polyphase fine sheet steel.

2. The steering wheel skeleton according to claim 1 wherein the polyphase fine sheet steel is a dual phase fine sheet steel.

3. The steering wheel skeleton according to claim 1 wherein the steering wheel skeleton is a deep-drawn steel sheet section.

4. The steering wheel skeleton according to claim 2 wherein the steering wheel skeleton is a deep-drawn steel sheet section.

5. The steering wheel skeleton according to one of claims 1 to 4, wherein for securing the hub to the steering wheel skeleton, a plane support plate extending essentially perpendicular to the steering wheel shaft is formed with an opening around the steering wheel shaft, and in that the hub is formed by a hub body having a top side, essentially the entire top side of the hub body is securely attached to the bottom side of the support plate, and downward projecting sheet parts of the support plate lie on the side surfaces of the hub between the spokes in a positive locking manner.

6. The steering wheel skeleton according to one of claims 1 to 4, wherein the hub comprises a hub projection which is inserted through the opening and which on the basis of its shaping is non-rotatably connected to the steering wheel skeleton.

7. The steering wheel skeleton according to claim 6 wherein the hub projection comprises a toothing on its circumference which engages a corresponding toothing on the inner circumference of the opening.

8. The steering wheel skeleton according claim 5 wherein the downward projecting sheet parts of the support plate have lower ends that are bent towards the axis of rotation of the steering wheel.

9. The steering wheel skeleton according to one of claims 1 to 4 wherein the rim has cross-section shape that is not solid.

10. A steering wheel skeleton according to one of claims 1 to 4 wherein spring-loaded latches are provided on the steering wheel skeleton for securing an airbag module thereto.

11. The steering wheel skeleton according to claim 10 wherein each spring-loaded latch comprises a leg spring on which an engagement part provided on the airbag module can be latched.

12. The steering wheel skeleton according to claim 10 wherein the engagement part is biased in the engagement position with a spring bias.

13. The steering wheel skeleton according to claim 12 wherein the engagement part is held in the spring-loaded latch with a spring bias.

14. The steering wheel skeleton according to claim 11 wherein the leg spring is a U-shaped spring.

15. The steering wheel skeleton according to claim 14 wherein a spring leg of the U-shaped spring is secured to the steering wheel skeleton and another spring leg of the U-shaped spring is resiliently movable and can be brought into engagement with the engagement part of the airbag module.

16. The steering wheel skeleton according to claim 15 wherein the resiliently movable spring leg extends across an opening provided in the sheet material of the steering wheel skeleton, through which the engagement part of the airbag module can be inserted.

17. The steering wheel skeleton according to claim 14 wherein the U-shaped spring is secured to a plunger secured to the bottom side of the airbag module, the two spring legs being biased outwardly from the U, which together with the plunger can be inserted as an engagement part into an opening a spokes in an interlocking manner.

18. The steering wheel skeleton according to claim 16 wherein the engagement part is held in the locked position between the two spring legs.

19. The steering wheel skeleton according to claim 17 wherein the engagement part is held in the locked position between the two spring legs.
